(19) United States
(12) Patent Application Publication
(10) Pub. No.: US 2010/0135396 A1
(43) Pub. Date: Jun. 3, 2010

(54) IMAGE PROCESSING DEVICE

(76) Inventors: Jung Hee SUK, Daejeon (KR); Chun-Gi LYUH, Daejeon (KR); Tae Moon ROH, Daejeon (KR); Jongdae KIM, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/540,722

(22) Filed: Aug. 13, 2009

(30) Foreign Application Priority Data
Dec. 3, 2008 (KR) 10-2008-0121789
Apr. 13, 2009 (KR) 10-2009-0031777

(51) Int. Cl. H04N 7/26

(52) U.S. Cl. 375/240.16; 375/240.26; 375/E07.104

(57) ABSTRACT

Provided is an image processing device. The image processing device includes: a plurality of operation units; and a controller unit storing an occurred bit amount to calculate a rate-distortion cost value and transmitting the occurred bit amount to each of the plurality of operation units, wherein at least one of the plurality of operation units calculates each distortion value with respect to a plurality of encoding modes and calculates each rate-distortion cost value with respect to the plurality of encoding modes using the calculated each distortion value and occurred bit amount.

### CROSS-REFERENCE TO RELATED APPLICATIONS

This U.S. non-provisional patent application claims priority under 35 U.S.C. §119 of Korean Patent Application No. 10-2009-0031777, filed on Apr. 13, 2009 and Korean Patent Application No. 10-2008-0121789, filed on Dec. 3, 2008, the entire contents of which are hereby incorporated by reference.

### BACKGROUND OF THE INVENTION

The present invention disclosed herein relates to an image processing device, and more particularly, to an image processing device for providing the optimized encoding mode based on a Rate-Distortion Optimization (RDO) technique.

H.264/AVC among moving picture encoding standards is a standard developed jointly in 2003 with International Organization for Standardization (ISO) of Moving Picture Experts Group (MPEG) using a recommend H series of International Telecommunications Union-Telecommunication Standardization Sector (ITU-T). The H.264/AVC focuses on a very high compression rate appropriate for a high capacity of moving picture contents as a main technical target, and is a general purpose moving picture encoding technique that can be commercialized in almost all environments such as broadcasting, internet, and storage media, and so forth.

The H.264/AVC has more diverse and excellent characteristics compared to typical compression standards.

Especially, the H.264/AVC uses the RDO technique in order to select the most optimized mode among encoding modes such as an inter mode, an intra mode, and a skip mode, such that the encoding mode can be determined. The RDO technique performs movement estimations, intra mode calculations, and skip condition tests with respect to all encoding modes in order to select the optimized mode. Accordingly, the H.264/AVC to which the RDO technique is applied requires a large amount of complex calculations.

### SUMMARY OF THE INVENTION

The present invention provides an image processing device for determining an optimized encoding mode first and then performing processes such as movement estimation and compensation, quantization, variable-length encoding, and inverse quantization.

The present invention also provides an image processing device for processing movement estimation and compensation, quantization, and inverse quantization in parallel according to an optimized encoding mode.

Embodiments of the present invention provide image processing devices including: a plurality of operation units; and a controller unit storing an occurred bit amount to calculate a rate-distortion cost value and transmitting the occurred bit amount to each of the plurality of operation units, wherein at least one of the plurality of operation units calculates each distortion value with respect to a plurality of encoding modes and calculates each rate-distortion cost value with respect to the plurality of encoding modes using the calculated each distortion value and occurred bit amount.

In some embodiments, the controller unit determines an encoding mode having the minimum value among the calculated each rate-distortion cost value.

In other embodiments, each of the plurality of operation units sequentially performs a movement estimation and compensation operation, a quantization process, a variable-length encoding process, and an inverse quantization process according to the determined encoding mode.

In still other embodiments, each of the plurality of operation units performs a movement estimation and compensation process, a quantization process, and an inverse quantization process in parallel according to the determined encoding mode.

In even other embodiments, the plurality of encoding modes includes at least one of an inter 16×16 mode, an inter 8×16 mode, an inter 16×8 mode, an inter 8×8 mode, an inter 8×4 mode, an inter 4×8 mode, and an inter 4×4 mode.

In yet other embodiments, the distortion value is calculated using one of a sum of absolute difference (SAD) method and a sum of square difference (SSD) method.

In further embodiments, the controller unit stores a Lagrange constant with respect to the plurality of encoding modes; and the rate-distortion cost value is a sum of the distortion value and a result value obtained by multiplying the occurred bit amount by the Lagrange constant

In still further embodiments, the occurred bit amount is generated by variable-length encoding a difference value and an index, the difference value being between an estimated movement vector and an average movement vector obtained by averaging estimated movement vectors, the index being of a reference frame referenced for generating the estimated movement vector.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a block diagram illustrating an image processing system according to an embodiment of the present invention;

FIG. 2 is a block diagram illustrating the image processing device of FIG. 1;

FIGS. 3A and 3B are conceptual diagrams illustrating a method of calculating an occurred bit amount;

FIG. 4 is a block diagram illustrating a memory map of the data memory of FIG. 2;

FIG. 5 is a flowchart illustrating operations of the first to fourth operation units of FIG. 2; and

FIGS. 6A and 6B are flowcharts illustrating the encoding mode determination operation of FIG. 5.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

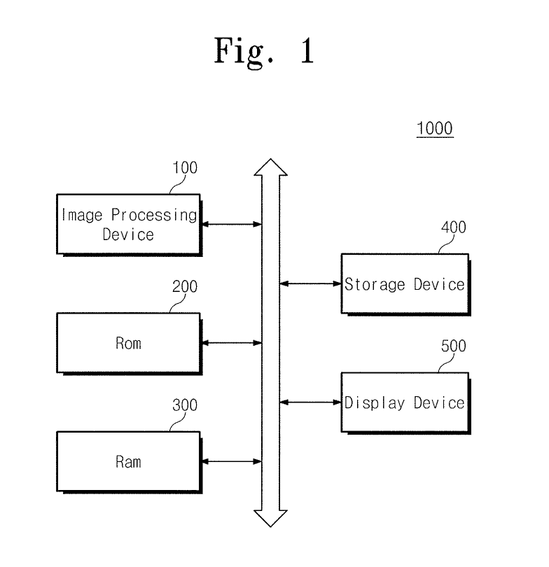

FIG. 1 is a block diagram illustrating an image processing system according to an embodiment of the present invention. An image processing system 1000 includes an image processing device 100, ROM 200, RAM 300, a storage device 400, and a display device 500.

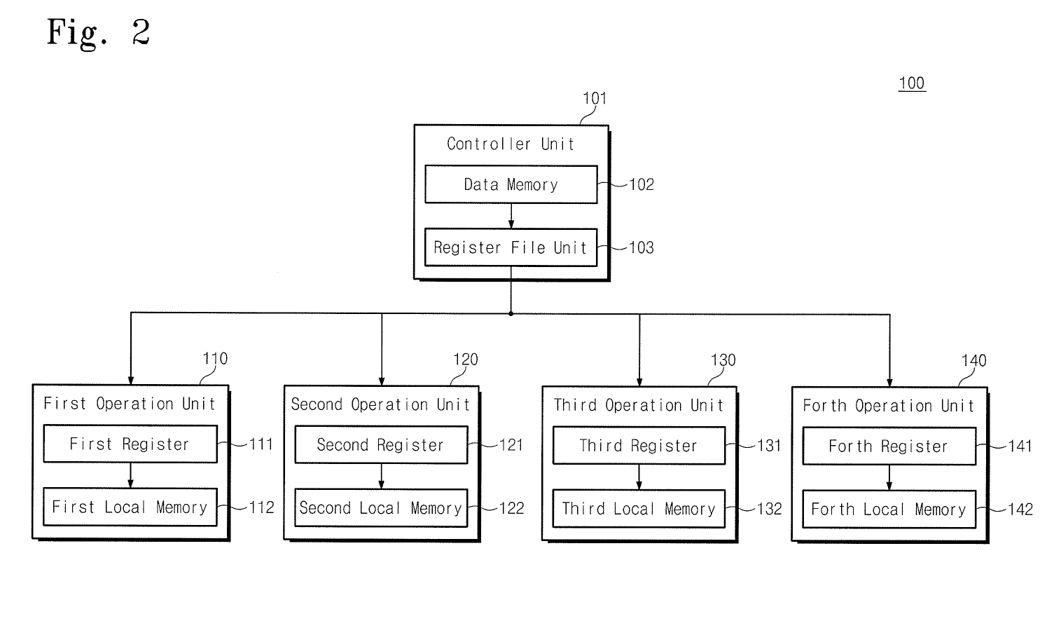

The image processing device 100 processes image data. The image processing device 100 performs processes such as encoding mode determination, movement estimation and compensation, quantization, variable-length encoding, and inverse quantization, in order for data processing. The image processing device 100 generates a bitstream as a data processing result. A structure and an operational principal of the image processing device 100 according to an embodiment of the present invention will be described in more detail with reference to FIG. 2.

The ROM 200 is a non-volatile memory device that retains information even if no power is applied. The ROM 200 stores a boot code for booting the image processing system 1000.

The RAM 300 is a memory that temporarily stores data to be stored in the storage device 400 or data read from the storage device 400. Additionally, the RAM 300 may be used as a working memory or a buffer memory for processing data of the image processing system 1000. Moreover, the RAM 300 may be realized with a static random access memory (SRAM) or a dynamic random access memory (DRAM), for fast data processing.

The storage device 400 stores image data. Here, the image data includes current frame data and a plurality of reference frame data. The plurality of reference frame data means data that are inputted before the current frame data. The storage device 400 may include a hard disk drive (HDD), a solid state drive (SSD), a flash memory device, for storing a large amount of image data.

The display device 500 displays a bitstream transmitted from the image processing device 100 on a screen. The display device 500 includes a liquid crystal display (LCD) monitor or a cathode ray tube (CRT) monitor.

The image processing system 1000 of FIG. 1 includes the image processing device 100 for processing image data. The image processing device 100 determines an optimized encoding mode first. Additionally, the image processing device 100 performs movement estimation and compensation, variable-length encoding, and inverse quantization processes sequentially through the optimized encoding mode. Moreover, the image processing device 100 performs movement estimation and compensation, quantization, and inverse quantization processes in parallel through the optimized encoding mode.

FIG. 2 is a block diagram illustrating the image processing device of FIG. 1. Referring to FIG. 2, the image processing device 100 includes a controller unit 101 and first to fourth operation units 110 to 140.

The controller unit 101 includes a data memory 102 and a register file unit 103. The data memory 102 stores instructions for controlling the first to fourth operation units 110 to 140, or an address or data for processing them. The register file unit 103 means an array of processor registers in a central processing device. In general, the register file unit 103 is realized with SRAM. The register file unit 103 transmits instructions or data, stored in the data memory 102, to the first to forth operation units 110 to 140. Or, the register file unit 103 temporarily stores data transmitted from the first to forth operation unit 110 to 140.

In addition, the data memory 102 stores an occurred bit amount and a Lagrange constant. Here, the occur bit amount is a bit amount that occurs when a difference value of a generated movement vector and a predicted movement vector and an index of a reference frame referenced for generating a movement vector are variable-length encoded. Additionally, the Lagrange constant is a constant provided to generate a rate-distortion cost value.

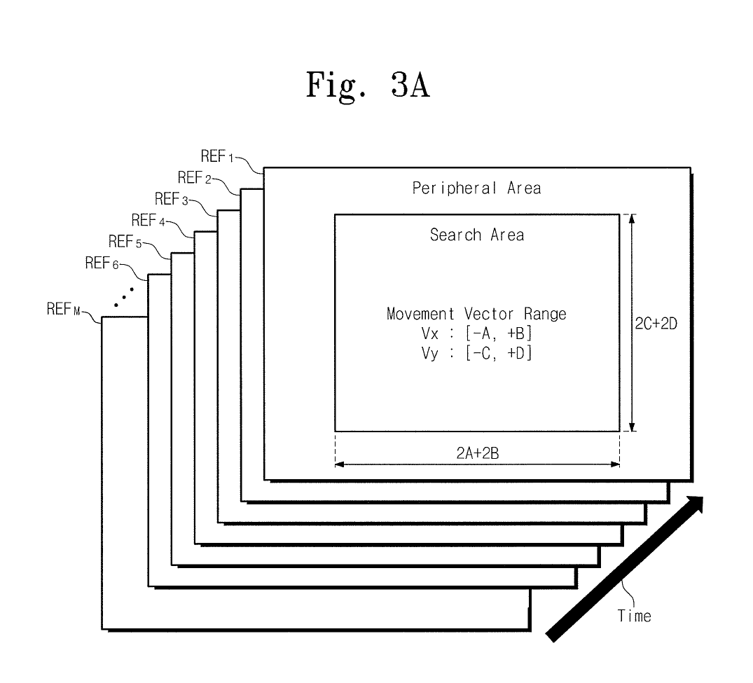

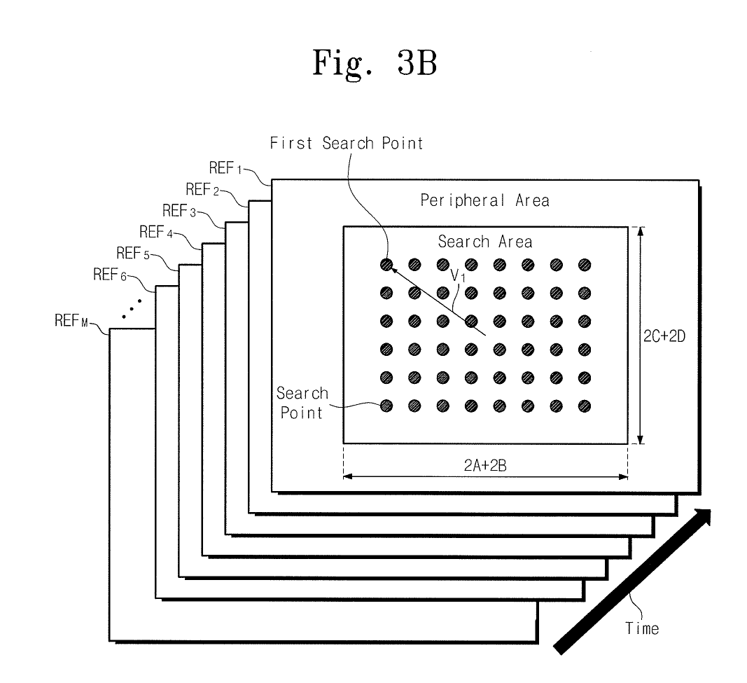

The occurred bit amount is calculated at all search points that are included a plurality of reference frames, respectively. The occurred bit amount is calculated before the optimized encoding mode is determined, and then is stored in the data memory 102. A method of calculating the occurred bit amount will be described with reference to FIG. 3.

FIGS. 3A and 3B are conceptual diagrams illustrating a method of calculating an occurred bit amount. FIG. 3A is a conceptual diagram illustrating first to M reference frames. FIG. 3B is a conceptual diagram illustrating N search points for the reference frame of FIG. 3A.

Referring to FIG. 3A, each of the first to M reference frames REF₁ to REF_{M} includes a peripheral area and a search area. Hereinafter, it is assumed that a movement vector is generated with reference to the first reference frame REF₁.

It is assumed that the search area includes 2A+2B in an x axis and 2C+2D in a y axis. Additionally, it is assumed that a range of the movement vector Vᵢ(Vₓ, V_{y}) is Vₓ[−A, +B] and V_{y}[−C, +D].

Referring to FIG. 3B, the search area includes N search points. Each of the N search points includes one movement vector Vi (1≦I≦N). The first movement vector V₁ is a movement vector corresponding to the first search point. In order to calculate one movement vector Vᵢ, several reference frames can be used. At this point, the used reference frame is indicated with REFⱼ (1≦j≦M). j represents an index of a reference frame. The reference frame will be a previous frame with respect to a current frame.

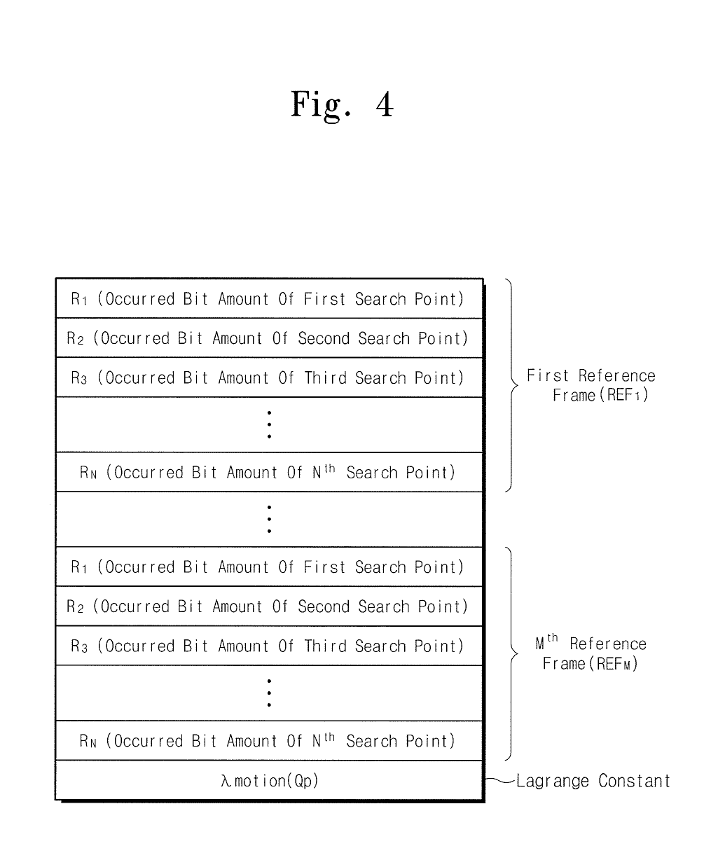

The occurred bit amount for the first search point is calculated by variable-length encoding a difference value of an estimated first movement vector V₁ and an averaged movement vector and an index j of the referenced reference frame REFⱼ. The averaged movement vector is calculated by averaging N movement vectors V₁ to V_{N}. The calculated occurred bit amount is stored in the data memory 102 of FIG. 2. A memory map of the data memory 102 according to an embodiment of the present invention is illustrated in FIG. 4.

FIG. 4 is a block diagram illustrating a memory map of the data memory of FIG. 2. Referring to FIGS. 2 and 4, in order to calculate one movement vector Vᵢ, the M reference frames REF₁ to REF_{M} are used.

The data memory 102 stores an occurred bit amount of the first search point with respect to the first reference frame REF₁ through an occurred bit amount of the N search point with respect to the M^{th} reference frame REF_{M}, and the Lagrange constant value λ_{motion(QP)}.

Referring FIG. 2 again, the image processing device 100 includes first to fourth operation units 110 to 140. Each of the first to fourth operation units 110 to 140 has the same operational principal. Accordingly, description related to the first operation unit 110 may be identically applied to the second to fourth operation units 120 to 140. Additionally, the image processing device 100 includes the four operation units 110 to 140 in FIG. 2, but may include more operation units or less operation units.

The first operation unit 110 includes a first register 111 and a first local memory 112. The first register 111 stores an instruction code that the first operation unit 110 executes and data according thereto. Additionally, the first register 111 stores data or instructions transmitted from the controller unit 101.

The first operation unit 110 may perform encoding mode determination, movement estimation and compensation, quantization, variable-length encoding, and inverse quantization processes sequentially. The second to fourth operation units 120 to 140 may sequentially perform these processes.

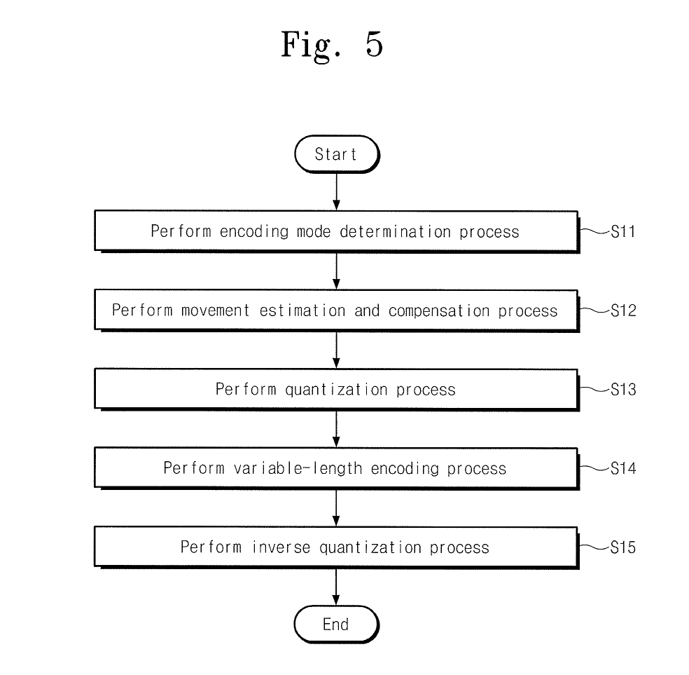

In addition, the first to fourth operation units 110 to 140 may process the movement estimation and compensation, quantization, and inverse quantization in parallel according to the first determined optimized encoding mode. For example, the first operation unit 110 performs a movement estimation and compensation process according to the optimized encoding mode. The second operation unit 120 performs a quantization process. The third operation unit 130 may perform an inverse quantization process. Each operation of the first to fourth operation units 110 to 140 is described with reference to FIG. 5.

FIG. 5 is a flowchart illustrating operations of the first to fourth operation units of FIG. 2.

Referring to FIGS. 2 and 5, each of the first to fourth operation units 110 to 140 performs encoding mode determination operation S11, movement estimation and compensation operation S12, quantization operation S13, variable-length encoding operation S14, and inverse quantization operation S15.

In the encoding mode determination operation S11, an encoding mode having the minimum rate-distortion cost value is selected from a plurality of encoding modes. The optimized movement vector can be calculated when a movement vector is calculated based on an encoding mode having the minimum rate-distortion cost value.

The encoding mode according to an embodiment of the present invention includes an inter 16×16 mode, an inter 8×16 mode, an inter 16×8 mode, an inter 8×8 mode, an inter 8×4 mode, an inter 4×8 mode, and an inter 4×4 mode.

The encoding mode determination operation S11 includes calculating a rate-distortion cost value using the calculated distortion value and occurred bit amount and determining an encoding mode having the minimum rate-distortion cost value among the calculated rate-distortion cost values.

In general, a method of calculating a distortion value includes a sum of absolute difference (SAD) method and a sum of square difference (SSD) method. Since the SAD calculation method requires less calculation amount than the SSD calculation method, the SAD calculation method is mainly used. The SAD calculation method adds up differences between a current frame and reference frames.

The rate-distortion cost value is calculated through Equation 1.

Rate-distortion cost value=distortion value+λ_{motion(Qp)}*Rₘₒₜᵢₒₙ where λ_{motion(QP)} is a Lagrange constant. Rₘₒₜᵢₒₙ is an occurred bit amount. That is, the rate-distortion cost value is the sum of the distortion value and a result that is obtained by multiplying the occurred bit amount by the Lagrange constant. [Equation 1]

In the movement estimation and compensation operation S12, the movement estimated and compensated image data are generated by comparing a current frame with a reference frame according to the encoding mode determined in S11.

In the quantization operation S13, the movement estimated and compensated image data are quantized.

In the variable-length encoding operation S14, image data that has a high probability with respect to the quantized image data are encoded with a short code and image data that has a low probability are encoded with a long code.

In the inverse quantization operation S15, the variable encoded image data are inversely quantized. The inverse quantized image data are used as a reference frame during the encoding mode determination operation S11 and the movement estimation and compensation operation S12.

Referring to FIG. 2 again, the controller unit 101 stores an occurred bit amount and a Lagrange constant value in the data memory 102. The register file unit 103 transmits the occurred bit amount and the Lagrange constant value stored in the data memory 102 into the first to fourth registers 111, 121, 131, and 141, respectively.

The first operation unit 110 stores the occurred bit amount and the Lagrange constant value stored in the first register 111 in the first local memory 112. The second operation unit 120 stores the occurred bit amount and the Lagrange constant value stored in the second register 121 in the second local memory 122. The third operation unit 130 stores the occurred bit amount and the Lagrange constant value stored in the third register 131 in the third local memory 132. The fourth operation unit 140 stores the occurred bit amount and the Lagrange constant value stored in the fourth register 141 in the fourth local memory 142. Each of the first to fourth operation units 110 to 140 performs an encoding mode determination operation.

In general, an optimized encoding mode using a rate-distortion optimization (RDO) technique is determined by performing movement estimation and compensation, quantization, variable-length encoding and inverse quantization processes on all encoding modes.

Accordingly, the present invention determines an optimized encoding mode first and performs processes such as movement estimation and compensation, quantization, variable-length encoding, and inverse quantization. Additionally, the present invention performs movement estimation and compensation, quantization, and inverse quantization processes in parallel according to an optimized encoding mode. For example, the first operation unit 110 performs a movement estimation and compensation process according to the optimized encoding mode. The second operation unit 120 performs a quantization process. The third operation unit 130 may perform an inverse quantization process.

In another example, the first operation unit 110 calculates a distortion value by applying the SAD calculation method for a 4×4 block. The first operation unit 110 calculates a rate-distortion cost for the 4×4 block using the calculated distortion value and an occurred bit amount stored in the first local memory 112.

The second operation unit 120 calculates a distortion value by applying the SAD calculation method for 8×4 and 4×8 blocks. The second operation unit 120 calculates a rate-distortion cost for the 8×4 and 4×8 blocks using the calculated distortion value and an occurred bit amount stored in the second local memory 122.

The third operation unit 130 calculates a distortion value by applying the SAD calculation method for an 8×8 block. The third operation unit 130 calculates a rate-distortion cost for the 8×8 block using the calculated distortion value and an occurred bit amount stored in the third local memory 132.

The fourth operation unit 140 calculates a distortion value by applying the SAD calculation method for a 16×16 block. The fourth operation unit 140 calculates a rate-distortion cost for the 16×16 block using the calculated distortion value and an occurred bit amount stored in the fourth local memory 142.

Hereinafter, it is assumed that the first operation unit 110 determines an encoding mode and its operation will be mainly described.

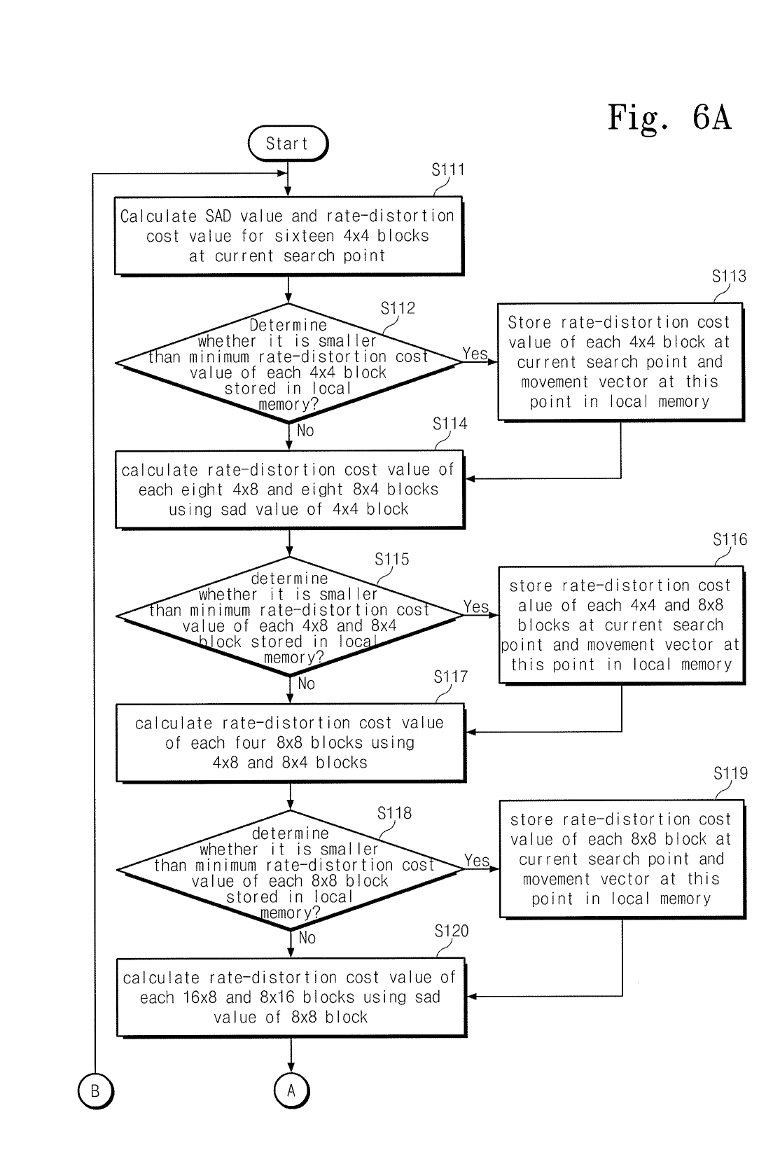

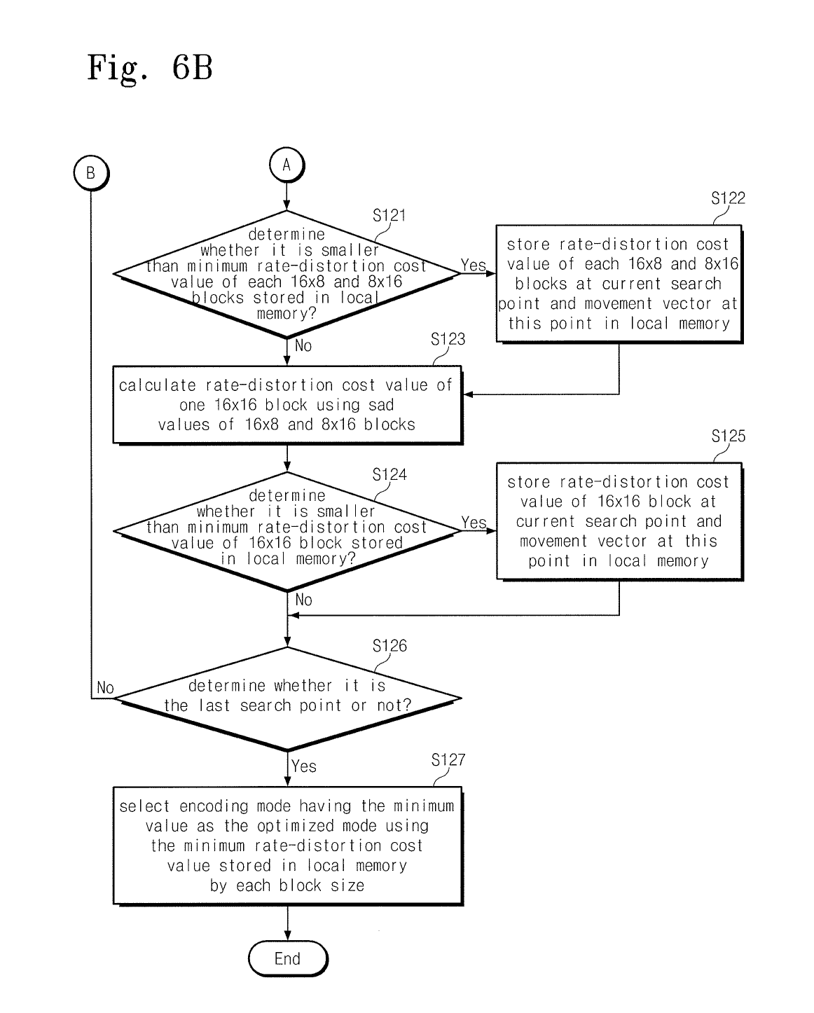

FIGS. 6A and 6B are flowcharts illustrating the encoding mode determination operation of FIG. 5. Referring to FIGS. 2, 6A, and 6B, as illustrated in FIG. 3A, the first operation unit 110 sets up a search area in a reference frame. As illustrated in FIG. 3B, the first operation unit 110 sets up N search points in the search area.

In operation S111, a first operation unit 110 selects a first search point. The first operation unit 110 calculates a distortion value by applying the SAD calculation method on sixteen 4×4 blocks. The first operation unit 110 calculates a rate-distortion cost value with respect to the sixteen 4×4 blocks using the calculated distortion value and the occurred bit amount stored in the first local memory 12 and it proceeds to operation S112. According to a preferred embodiment, the distortion value is calculated by applying the SAD calculation method.

In operation S112, the first operation unit 110 determines whether it is smaller than the minimum rate-distortion cost value of each 4×4 block stored in the first local memory 112. If there is no previously stored minimum rate-distortion cost value, the first operation unit 110 proceeds to operation S113.

For example, if a distortion value and a rate-distortion cost of the sixteen 4×4 blocks with respect to a second search point are calculated in operation S111, the first operation unit 110 compares the minimum rate-distortion cost value for the first search point with the minimum rate-distortion cost value for the second search point. The first operation unit 110 proceeds to operation S113 if the minimum rate-distortion cost value for the second search point is smaller, and if not, it proceeds to operation S114.

In operation S113, the first operation unit 110 stores the rate-distortion cost value of the 4×4 block for the first search point and a movement vector in the first local memory 112, and it proceeds to operation S114. In operation S114, the first operation unit 110 calculates the rate-distortion cost for eight 4×8 and eight 8×4 blocks using a distortion value for the 4×4 block and the occurred bit amount stored in the first local memory 112 and it proceeds to operation S115. In operation S115, the first operation unit 110 determines whether it is smaller than the minimum rate-distortion cost value of each eight 4×8 and eight 8×4 blocks stored in the first local memory 112. If there is no previously stored minimum rate-distortion cost value, the first operation unit 110 proceeds to operation S116.

For example, if a rate-distortion cost of the eight 4×8 and eight 8×4 blocks with respect to a second search point is calculated in operation S114, the first operation unit 110 compares the minimum rate-distortion cost value for the first search point with the minimum rate-distortion cost value for the second search point. The first operation unit 110 proceeds to operation S116 if the minimum rate-distortion cost value for the second search point is smaller, and if not, it proceeds to operation S117.

In operation S116, the first operation unit 110 stores a rate-distortion cost value of the eight 4×8 and eight 8×4 blocks and a movement vector with respect to the first search point in the first local memory 112, and it proceeds to operation S117.

In operation S117, the first operation unit 110 calculates the rate-distortion cost for four 8×8 blocks using a distortion value for the 4×4 and 8×4 blocks and the occurred bit amount stored in the first local memory 112 and it proceeds to operation S118. In operation S118, the first operation unit 110 determines whether it is smaller than the minimum rate-distortion cost value of each four 8×8 blocks stored in the first local memory 112. If there is no previously stored minimum rate-distortion cost value, the first operation unit 110 proceeds to operation S119.

For example, if a rate-distortion cost of the four 8×8 blocks with respect to a second search point is calculated in operation S117, the first operation unit 110 compares the minimum rate-distortion cost value for the first search point with the minimum rate-distortion cost value for the second search point. The first operation unit 110 proceeds to operation S119 if the minimum rate-distortion cost value for the second search point is smaller, and if not, it proceeds to operation S120.

A of FIG. 6A is connected to A of FIG. 6B, and B of FIG. 6A is connected to B of FIG. 6B.

In operation SI 19, the first operation unit 110 stores a rate-distortion cost value of the 8×8 block with respect to the current search point and the movement vector in the first local memory 112, and it proceeds to operation S120.

In operation S120, the first operation unit 110 calculates the rate-distortion cost for two 16×8 and 8×16 blocks using a distortion value for the 8×8 block and the occurred bit amount stored in the first local memory 112 and it proceeds to operation S121. The distortion value for the 8×8 block is calculated using distortion values for the 4×8 and 8×4 blocks. In operation S121, the first operation unit 110 determines whether it is smaller than the minimum rate-distortion cost value of each two 16×8 and 8×16 blocks stored in the first local memory 112. If there is no previously stored minimum rate-distortion cost value, the first operation unit 110 proceeds to operation S122.

For example, if a rate-distortion cost of the two 16×8 and 8×16 blocks with respect to a second search point is calculated in operation S120, the first operation unit 110 compares the minimum rate-distortion cost value for the first search point with the minimum rate-distortion cost value for the second search point. The first operation unit 110 proceeds to operation S122 if the minimum rate-distortion cost value for the second search point is smaller, and if not, it proceeds to operation S 123.

In operation S122, the first operation unit 110 stores a rate-distortion cost value of the two 16×8 and 8×16 blocks with respect to the current search point and a movement vector in the first local memory 112, and it proceeds to operation S123.

In operation S123, the first operation unit 110 calculates the rate-distortion cost for one 16×16 block using a distortion value for the 16×8 and 8×16 blocks and the occurred bit amount stored in the first local memory 112 and it proceeds to operation S124. The distortion value for one 16×16 block is calculated using distortion values for the 16×8 and 8×16 blocks. In operation S124, the first operation unit 110 determines whether it is smaller than the minimum rate-distortion cost value of one 16×16 block stored in the first local memory 112. If there is no previously stored minimum rate-distortion cost value, the first operation unit 110 proceeds to operation S125.

For example, if a rate-distortion cost of 2 16×16 blocks with respect to a second search point is calculated in operation S123, the first operation unit 110 compares the minimum rate-distortion cost value for the first search point with the minimum rate-distortion cost value for the second search point. The first operation unit 110 proceeds to operation S125 if the minimum rate-distortion cost value for the second search point is smaller, and if not, it proceeds to operation S126.

In operation S126, the first operation unit 110 determines whether it is the last search point or not. The first operation unit 110 determines whether all operations S111 to S215 are performed on each N search point (N is the number of search points). If it is not the last search point, the first operation unit 110 repeatedly returns to operation S111 and if it is the last search point, it proceeds to operation S127.

For example, if all operations S111 through S125 are completed on the first search point, the first operation unit 110 selects a second search point in operation S111, and calculates a distortion value and a rate-distortion cost value for sixteen 4×4 blocks, and it proceeds to operation S112. The first operation unit 110 repeatedly performs operations S111 to S125 on all the N search points until the last Nth search point is completed.

In operation S127, the first operation unit 110 selects an optimized mode having the minimum value among encoding modes by comparing the minimum rate-distortion cost value stored in the first local memory 112 by each block size.

Accordingly, the present invention determines an optimized encoding mode first and then performs processes such as movement estimation and compensation, quantization, variable-length encoding, and inverse quantization. Additionally, the present invention performs movement estimation and compensation, quantization, and inverse quantization processes in parallel according to an optimized encoding mode.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An image processing device comprising:
a plurality of operation units; and
a controller unit storing an occurred bit amount to calculate a rate-distortion cost value and transmitting the occurred bit amount to each of the plurality of operation units,
wherein at least one of the plurality of operation units calculates each distortion value with respect to a plurality of encoding modes and calculates each rate-distortion cost value with respect to the plurality of encoding modes using the calculated each distortion value and occurred bit amount.

2. The image processing device of claim 1, wherein the controller unit determines an encoding mode having the minimum value among the calculated each rate-distortion cost value.

3. The image processing device of claim 2, wherein each of the plurality of operation units sequentially performs a movement estimation and compensation operation, a quantization process, a variable-length encoding process, and an inverse quantization process according to the determined encoding mode.

4. The image processing device of claim 2, wherein each of the plurality of operation units performs a movement estimation and compensation process, a quantization process, and an inverse quantization process in parallel according to the determined encoding mode.

5. The image processing device of claim 1, wherein the plurality of encoding modes comprises at least one of an inter 16×16 mode, an inter 8×16 mode, an inter 16×8 mode, an inter 8×8 mode, an inter 8×4 mode, an inter 4×8 mode, and an inter 4×4 mode.

6. The image processing device of claim 1, wherein the distortion value is calculated using one of a sum of absolute difference (SAD) method and a sum of square difference (SSD) method.

7. The image processing device of claim 1, wherein:
the controller unit stores a Lagrange constant with respect to the plurality of encoding modes; and
the rate-distortion cost value is a sum of the distortion value and a result value obtained by multiplying the occurred bit amount by the Lagrange constant

8. The image processing device of claim 1, wherein the occurred bit amount is generated by variable-length encoding a difference value and an index, the difference value being between an estimated movement vector and an average movement vector obtained by averaging estimated movement vectors, the index being of a reference frame referenced for generating the estimated movement vector.
